(19) United States
(12) Patent Application Publication
(10) Pub. No.: US 2006/0280355 A1
(43) Pub. Date: Dec. 14, 2006

(54) Method of evaluating and designing sealing elements

(76) Inventor: Rhex Edwards, Whitmore Lake, MI (US)

Correspondence Address: BUTZEL LONG, 350 SOUTH MAIN STREET, SUITE 300, ANN ARBOR, MI, 48104, US

(21) Appl. No.: 11/152,757

(22) Filed: Jun. 14, 2005

(51) Int. Cl. G06K 9/00

(52) U.S. Cl. 382/141

(57) ABSTRACT

A method of non-invasively evaluating how sealing elements will perform under compression between two adjacent structures which involves obtaining and manipulating three dimensional images of opposed surfaces of the adjacent structures so as to create an image that shows how a sealing element is compressed between the adjacent structures, which image is otherwise concealed. The performance of the sealing element can be evaluated by included an image of the seal configuration and information as to the properties of the material from which the sealing element is made. The evaluation can be used in the designing or redesigning of sealing elements.

### TECHNICAL FIELD

The present invention relates to sealing elements that are used to provide fluid barriers between two adjacent structures. More particularly, the present invention relates to a noninvasive method of evaluating how sealing elements will perform under compression between two adjacent structures. Even more particularly, the present invention relates to a noninvasive method of evaluating the performance automotive door sealing elements that can be used to properly attach doors and door seals to automobile bodies and used to design or redesign door sealing elements.

### BACKGROUND ART

Robotic equipment is used today to assemble, weld, finish, gauge and test manufactured articles with a much higher degree of quality and precision than has been heretofore possible. Machine vision is a key part of today's manufacturing environment. Machine vision systems are used with robotics and computer-aided design systems to ensure high quality is achieved at the lowest practical cost.

Achieving high quality manufactured assemblies requires highly accurate, tightly calibrated machine vision sensors. Not only must a sensor have a suitable resolution to discern a feature of interest, the sensor must be accurately calibrated to a known frame of reference so that the feature of interest may be related to other features on the workpiece or in a work station. Without accurate calibration, even the most sensitive, high resolution sensor will fail to produce high quality results.

In a typical manufacturing environment, there may be a plurality of different non-contact sensors, such as optical sensors, positioned at various predetermined locations within the workpiece manufacturing, assembly, gauging or testing station. A workpiece is placed at a predetermined, fixed location within the station, allowing various predetermined features of the workpiece to be examined by the sensors. All of the sensors are properly positioned and have to be carefully calibrated with respect to some common fixed frame of reference, such as a common reference frame on the workpiece or in or near the workstation.

Accuracy of workpiece manufacturing, assembly, gauging or testing requires keeping sensors properly positioned and calibrated in environments in which the sensors and their associated mounting structures may get bumped or jarred, throwing the sensor out of alignment.

Quick and accurate calibration of sensors can be achieved according to the invention in U.S. Pat. Nos. 6,128,585 and 5,748,505 to Greer.

The use of robotic equipment and machine vision sensors to fit and attach doors to vehicle bodies during assembly has been refined to the point at which gaps between the edges of the doors and the edges of the door openings can be accurately gauged and adjusted to ensure proper alignment and operation of the doors.

Although it is possible to accurately align and attached doors to vehicle bodies using robotic equipment and machine vision sensors, to date there exists no noninvasive method of evaluating how sealing elements will perform under compression between the edges of vehicle doors and the adjacent edges of door openings. Because such sealing elements are typically not visible when the doors are in their closed position, it is not possible to visually evaluate the performance of the sealing elements.

Nevertheless, there exists a need for an accurate method of evaluating how sealing elements will perform under compression between the edges of vehicle doors and the adjacent edges of door openings. Poor sealing performance between vehicle doors and vehicle bodies can result in wind noise as the vehicle is being driven at higher speeds, or water leakage into the interior of the vehicle. In addition, poor sealing performance can result in excessive force being necessary to close a door, resulting in having to “slam” a door closed.

Proper sealing performance is important and can be appreciated when considering that a relatively inexpensive sealing element on a comparably expensive vehicle can cause owner dissatisfaction if wind noise is too noticeable to the owner, regardless how well the vehicle may otherwise perform and meet expectations.

The present invention provides a noninvasive method of evaluating how sealing elements will perform under compression between two adjacent structures such as a vehicle door and an adjacent opening in a vehicle body. In addition, the method of evaluating sealing element performance according to the present invention can be used to design or redesign sealing element configurations.

### DISCLOSURE OF THE INVENTION

According to various features, characteristics and embodiments of the present invention which will become apparent as the description thereof proceeds, the present invention provides a method of evaluating the performance of sealing elements that are confined between adjacent surfaces which method involves the steps of:

a) providing a first surface structure and a second surface structure which can be moved with respect to one another between a first close proximity position and a second spaced apart position;

b) providing at least one sealing element on one of the first surface structure and the second surface structure;

c) obtaining a three dimensional image of each of the first and second surface structures with the at least one sealing element thereon;

d) arranging the three dimensional images of the first and second surface structures in the first close proximity position and identifying areas where the three dimensional image of the at least one sealing element will intersect the image of the opposed surface structure when the first and second surface structures in arranged in the first close proximity position; and

e) evaluating from the three dimensional images how the at least one sealing element will interact with and between the first and second surface structures in the first close proximity position.

The present invention further provides a method of evaluating the performance of sealing elements that are confined between compartment openings and closures configured to seal at least a portion of a compartment opening, the method involving the steps of:

a) providing a compartment having an opening therein, the opening including a peripheral opening surface area;

b) providing a closure configured to seal at least a portion of the compartment opening, the closure having both inner and outer surfaces;

c) providing a three dimensional reference image of the closure positioned so as to seal the opening;

d) providing and combining three dimensional images of the inner and outer surfaces of the closure to produce a combined three dimensional closure image;

e) providing a three dimensional image of the peripheral opening surface area;

f) aligning the combined three dimensional closure image with the three dimensional image of the peripheral opening surface area so as to confirm to the three dimensional reference image;

g) incorporating the configuration of at least one sealing element between the three dimensional image of the inner surface of the door and the three dimensional image of the peripheral opening surface area in step f); and

h) evaluating how the at least one sealing element interacts with and between the three dimensional image of the inner surface of the door and the three dimensional image of the peripheral opening surface area in step g).

The present invention further provides a method of designing sealing elements which involves, based upon evaluation of sealing element performance, redesigning a configuration of sealing element to improve the performance thereof.

### BRIEF DESCRIPTION OF DRAWINGS

The present invention will be described with reference to the attached drawings which are given as non-limiting examples only, in which:

FIG. 1 is perspective side view of a vehicle which depicts the location of target areas according to one embodiment of the present invention.

FIG. 2 is a perspective side view of a vehicle which depicts the process of image scanning the gap and flush of a door in the door's fully closed and latched position.

FIG. 3 is a perspective side view of a vehicle which depicts the process of image scanning the inner surface(s) of a door.

FIG. 4 depicts the process of image scanning body side door opening surface(s) of a door.

FIG. 5 is a graphical illustration of how the data of the inner and outer scanned images of the door is manipulated so that these images are positionally aligned to produce a combined image of the complete edge of the door.

FIG. 6 is a graphical illustration of how the data of the combined image of the edge of the door and the scanned image of the body side of the door opening are aligned into a position in which the door is fully closed and latched.

FIG. 7 is depicts a cross-section analysis of the image data as combined in FIG. 6 and taken along section lines 7-7 in FIG. 2.

FIG. 8 is a scanned image of the body side of a door with a door seal attached.

FIG. 9 is an image of the complete edge of the door formed by merging the inner and outer door scan.

FIG. 10 is a combined image of the door scan and the merged the inner and outer door scan.

### BEST MODE FOR CARRYING OUT THE INVENTION

The present invention is directed to a noninvasive method of evaluating how sealing elements will perform under compression between two adjacent structures. As will be explained in detail below, the method of evaluating sealing element performance according to the present invention can be used to design or redesign sealing element configurations.

The method of evaluating how sealing elements perform according to the present invention was originally developed to evaluate the performance of sealing elements that are used between vehicle doors and adjacent door openings or frames of vehicle bodies. However, it is to be understood that the method of evaluating sealing element performance as described below in reference to vehicle doors and vehicle assemblies is not limited to such structures. The method of evaluating sealing element performance according to the present invention can be used to evaluate the performance of sealing elements between any two structures and is applicable in the general assembly of vehicles, including automobiles, trucks, vans, sport utility vehicles, etc. and in the assembly of ships, boats, vessels, aircraft, spacecraft, and other structures that require sealing. Moreover, in addition to evaluating sealing element performance of vehicle door seals, the present invention can be used to evaluate the performance of sealing elements are used to seal any fixed vehicle glass, including windshields, rear window glass, etc. and fixed or movable roof glass (e.g. sunroofs or moonroofs) and engine compartment hoods.

The method of evaluating sealing element performance according to the present invention is noninvasive and does not require disassembly or removal of parts of an assembly or even contact with an assembly. The method of evaluating sealing element performance according to the present invention is simple for an operator to perform, is highly accurate and relatively quick, enabling the method to be used in quality control programs for test samplings from production assembly lines.

Because the method of evaluating sealing element performance according to the present invention provides information as to how sealing elements having different configurations and/or made from different compositions are compressed, deflected, distorted, etc. between the surfaces of adjacent structures, the present invention can be used in the design or redesign of sealing element profiles, configurations and alignment.

The present invention makes use of several technologies that are commercially available, including three-dimensional, non-contact image scanning technologies in combination with manipulators for mounting and fixing reference points or reference frames for image scanners, and software that manipulates image date.

In reference to evaluation of vehicle door sealing elements, the method of evaluating sealing element performance according to the present invention involves first establishing target areas on a vehicle door and on the adjacent structure of the vehicle. As discussed in detail below, these target areas are used to establish positional reference points of the vehicle door and door opening.

Once target areas are established, the gap between the door and surrounding structure of the vehicle and flush surfaces of the door and surrounding structure of the vehicle are imaged scanned. The resulting image data, which provides an outer image of the door, serves as a reference for the position of the door with respect to the door opening when the door is in its fully closed and latched position.

Next, the door inner surface(s) are scanned together with the target areas on the outer surface of the door. During this imaging scanning step it is not necessary to scan the entire outer surface edge of the door. However, image scanning the target areas will enable establishing reference points on the scanned image of the door inner surface(s) for subsequent image manipulation as discussed below.

Next, the body side surfaces of the door opening are scanned together with the target areas on the outer surface of the structure defining the door opening and any sealing element profile(s) included.

Using conventional point cloud data handling software the inner and outer scanned images of the door are positionally aligned to produce a combined image of the complete three-dimensional profile of the edge of the door with any sealing element profile(s) included.

Further using conventional point cloud handling software, the combined image of the door and the scanned image of the body side of the door opening are aligned into a position which corresponds to the door being fully closed and latched as determined from the scanned image of the gap between the door and surrounding structure of the vehicle and flush surfaces of the door and surrounding structure of the vehicle.

From the aligned image of the door (the “combined” inner and outer scanned images) and of the body side of the door opening, cross-section analysis can be performed at any desired position to determine areas of interference or non-contact between the aligned images. Further analysis incorporating the geometry and properties of the sealing element(s) can be used to identify and analyze misaligned regions, improper seal fit or contact, degree of seal compression, any seal cavity geometry changes, obstructed seal areas, seal spacing, regions that result in noise, water and/or wind issues, door deformation resulting from excessive seal pressure, etc. In addition to evaluating the performance of sealing elements, the analysis information can be used to design or redesign and test (by simulation or actual physical testing) changes in seal geometry (for redesigned seals) or new sealing element designs.

In reference to evaluation of vehicle door sealing elements, the seal element evaluating method of the preset invention can be used any time after the doors are attached to a vehicle body, including post-assembly of the vehicle. The method can be used in conjunction with any vehicle color or color scheme and is completely non-destructive and only involves non-contact image technologies. The method does not involve the use of any developers of markers on the seals or seal surfaces. The method provides a high degree of accuracy and is relatively quick so that it can be used in quality control programs to identify and contain non-conforming vehicle assemblies. Moreover the method can be used to identify non-conforming areas of sealing elements and provide information as to how to correct the non-conformity, thus helping in repair and sealing element design.

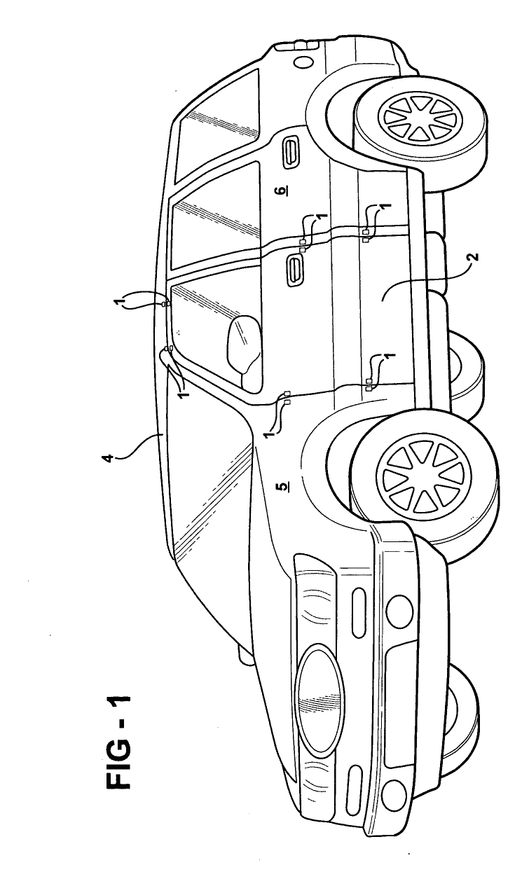

FIG. 1 is perspective side view of a vehicle which depicts the location of target areas according to one embodiment of the present invention. The door of the vehicle depicted in FIG. 1 is shown in its fully closed and latched position. With the door in this position pairs of target areas 1 are provided along the peripheral edge of the door 2 with one member from each pair being located on the door 2 and the other member of each pair being located on an adjust structure which defines the door opening, e.g. the rocker panel 3, roof 4, fender 5, and adjacent door 6 (for 4-door vehicles) for purpose of image manipulating as discussed below. The target areas 1 are used to provide spatial reference points by which the scanned images discussed below can be spatially referenced and manipulated, i.e. aligned and combined as desired. The only limitation on the target areas 1 is that they be identifiable in the scanned images. Thus, the target areas 1 can be any mark, or any two-dimensional or three dimensional element removably applied or attached to the vehicle or any discrete portion or shape or contour of the vehicle that can be identifiable in the scanned images. During the course of the present invention it was determined that target areas 1 that can be magnetically attached to the vehicle would be ideally suitable for purposes of evaluating sealing elements and would not result in any permanent marks on the vehicle. For example, a light reflective tab, or sphere, tetrahedron, or other three-dimensional shape coupled to a magnet would provide a suitable target area. FIG. 1 depicts the use of six pair of target areas 1 with two spaced apart pairs along the top and each side of the door. More or fewer pairs of target areas 1 could be used if desired. Moreover, the pair members of the target area pairs do not have to be aligned exactly adjacent one another on either side of the gap between the door 2 and adjacent structure which defines the door opening. The pair members of the target areas 1 could be staggered from one another on either side of the gap that exists between the door 2 and adjacent structure which defines the door opening rather than being adjacent to one another.

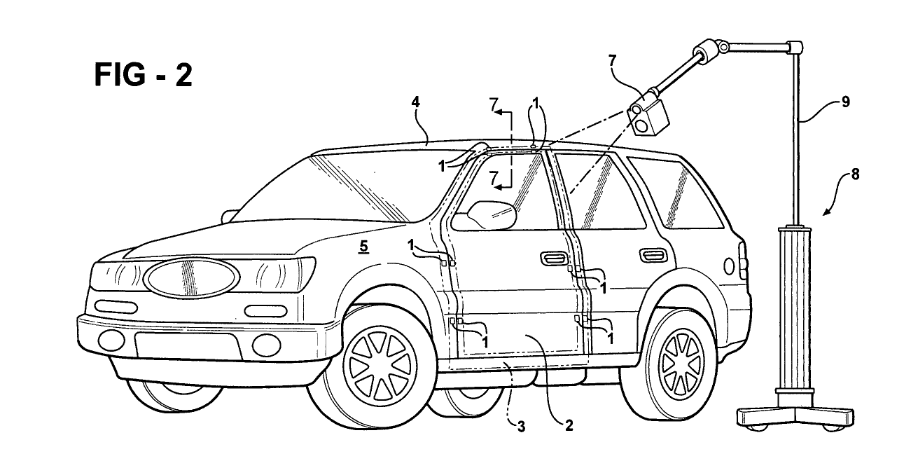

FIG. 2 is a perspective side view of a vehicle which depicts the process of image scanning the gap and flush of a door in the door's fully closed and latched position. The door 2 of the vehicle depicted in FIG. 2 is shown in a fully closed and latched position with the target areas 1 of FIG. 1 provided on the door 2 and surrounding structure that defines the door opening. The door 2 has been properly assembled to the vehicle body with the gap between the door 2 and the surrounding structure that defines the door opening being properly adjusted as desired and the outboard surface contour of the door 2 being adjusted to be flush with the outboard surface of the surrounding structure that defines the door opening as desired. In this position, an image is scanned along the gap between the door 2 and the surrounding structure that defines the door opening which image includes peripheral edges of both the door and the surrounding structures so as to include the target areas 1. This scanned image which is referred to herein as the “gap and flush” scan or image includes an image of the outer surface of the door 2 which is discussed in more detail below.

The gap and flush image can be scanned using any conventional three-dimensional image scanner. One example of a suitable three-dimensional image scanner that can be used for purposes of the present invention is the Scanworks™ Contour Probe (available from Perceptron, Inc., Plymouth, Mich.). The Scanworks™ Contour Probe operates on the principle of laser triangulation, using a plane of laser light that is projected onto an object. Light reflected form the scanned object is detected and analyzed to build up the shape of the scanned object into a cloud of data points. Other types of image scanners that produce three dimensional surface images including those that use laser triangulation or those that operate on other principles can also be used. In FIG. 2 the scanner 7 is depicted as being connected to a manipulator 8. The manipulator 8 includes a multiple jointed arm 9 that is used to establish and maintain a reference position from which the spatial position and/or orientation of one or more objects can be determined. Some examples of manipulators include coordinate measuring machines (CMMs), articulated arms (PCMMs), and robotic arms. The movement of the scanner 7 (and scanning of an object) can be performed automatically such as by a computer program controlling movement of the manipulator 8, or manually by having an operator physically move the scanner 7. According to one embodiment of the present invention a portable coordinate measuring machine is used and manipulated manually by moving the scanner 7. The general use of image scanners in cooperation with manipulators to scan and produce three dimensional images and image data is known. The present invention is directed to a method which, in part, involves a novel application of image scanners used in cooperation with manipulators.

The gap and flush of the door 2 in FIG. 2 is imaged scanned by aiming and moving the scanner 7 along the gap and flush area of the door 2 and adjust structure. The resulting data image can be displayed and is otherwise stored for subsequent processing as discussed below. The path along which the gap and flush of the door 2 is imaged scanned in FIG. 2 is depicted in broken lines. It is to be understood that in all the image scanning procedures, portions or entire scan paths can be rescanned if desired.

The image data obtained from image scanning the gap and flush of the door (with the target areas provided thereon) provides a reference when subsequent images of the door and door opening are processed and manipulated so as to be aligned and positioned as if the door were in the closed position depicted in FIG. 2.

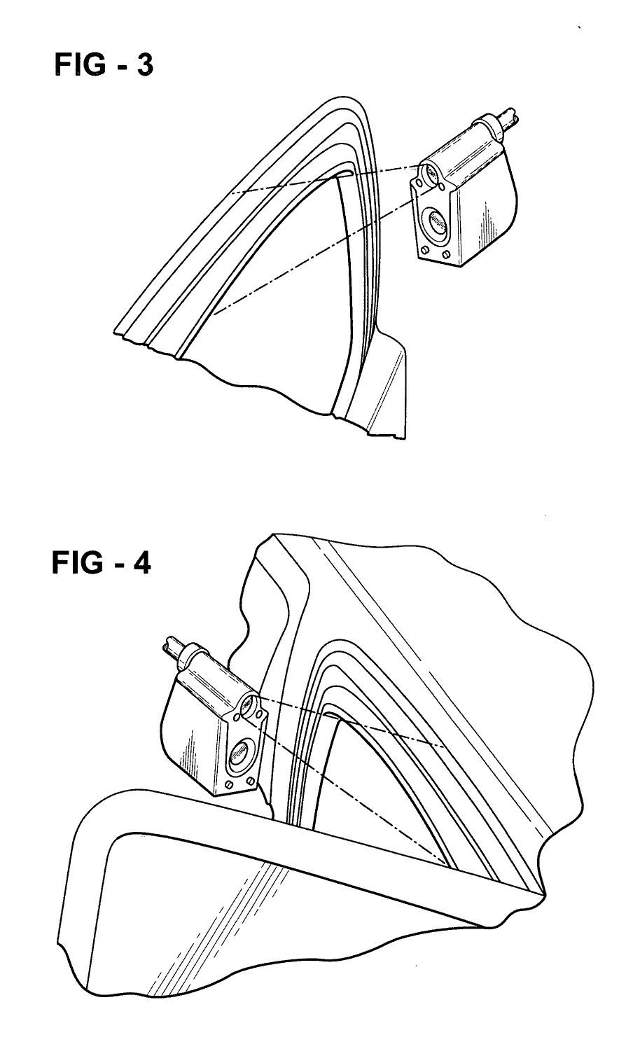

FIG. 3 is a perspective side view of a vehicle which depicts the process of image scanning the inner surface(s) a door. Once the gap and flush of the door 2 has been imaged scanned, the door 2 is opened and the scanner 7 and manipulator 8 shown in FIG. 2 are used to scan the inner surface(s) of the door 2 as depicted in FIG. 3. It is noted that the inner surface(s) of the door 2 depicted in FIG. 3 includes sealing element engaging surfaces 10 and 11 which are included in the scanned image of the inner surface(s) of the door 2. It is important to include the target areas 1 in the scanned image of the inner surface(s) of the door 2. This can be achieved by manipulating and aiming the scanner 7 at the target areas 1 which will then be included in the scanned three-dimensional image.

FIG. 4 is a perspective side view of a vehicle which depicts the process of image scanning the body side door opening surfaces. Once the gap and flush of the door 2 has been imaged scanned and the inner surface(s) of the door have been imaged scanned (with the target areas), the scanner 7 and manipulator 8 shown in FIG. 2 are used to scan the body side door opening surfaces as depicted in FIG. 4. It is noted that the body side door opening surface(s) depicted in FIG. 4 can include one or more sealing elements 12 and 13 which will be included in the scanned image of the body side door opening surfaces. It is important to include the target areas 1 (provided on the structure that defines and surrounds the door opening) in the scanned image of the body side door opening surfaces. This can be achieved by manipulating and aiming the scanner 7 at the target areas 1 which will then be included in the scanned three-dimensional image. In FIG. 4 a portion of the door frame is shown which can comprise any of the structure that surrounds and defines the door opening including a rocker panel, roof 4, fender, adjacent door, door post 15, etc. It is to be understood that while FIGS. 3 and 4 depict an automobile door that includes two sealing elements attached to the body side door opening surfaces, it is possible to use the method of the present invention to evaluate and design sealing elements that are to be attached to the inner surfaces of a door and/or both the inner surfaces of a door and body side door opening surfaces.

It is noted that the order of image scanning the gap and flush of the door as depicted in FIG. 2, image scanning the inner surface(s) of the door as depicted in FIG. 3, and image scanning the body side door opening surface(s) as depicted in FIG. 4, can be performed in any order so long as the target areas are not moved and the spatial reference for the scanner 7 is either not changed or other measures are taken such as standardizing dimensions of the scanned images so that the scanned images can be manipulated and combined as discussed herein.

The scanned image of the gap and flush of the door, the scanned image of the inner surface(s) of the door and the scanned image of the body side door opening surface(s) each provide an image data set that can be manipulated using commercially available software packages.

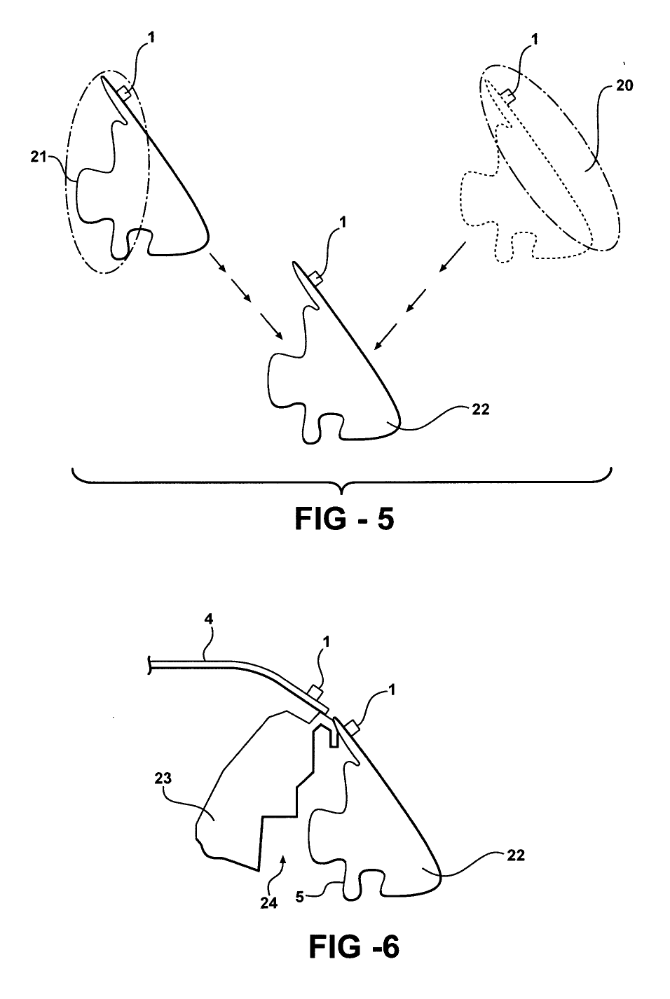

FIG. 5 is a graphical illustration of how the data of the inner and outer scanned images of the door is manipulated so that these images are positionally aligned to produce a combined image of the complete edge of the door with any sealing element structures included. The purpose of combining the images of the inner and outer surfaces of the door is so that when the resulting combined image is positioned with the outer surface of the door aligned to match the gap and flush position of the door from the scanned image of the gap and flush of the door, the inner surface of the door (of the combined image of the inner and outer surfaces) will be in the normal position of the inner surface of the physical door when the door is in the closed and latched position. This process enables the generation of a visible image and analysis of the area of the door seal which is normally concealed when a vehicle door is closed.

The scanned image 20 of the outer surface of the door 2 (which can be extracted from the scanned image of the gap and flush of the door) is aligned with the scanned image 21 of the inner surface of the door 2 using the cloud point data obtained during the image scanning and conventional software such as Polyworks® which allows manipulation of cloud point data sets. In FIG. 5 the image 20 of the outer surface of the door 2 is depicted as being aligned and merged with the image 21 of the inner surface of the door 2 to form an image data set 22 of the combined outer and inner surfaces of the door 2. It can be seen in FIG. 5 that the image of the target area 1 on the individual images of the outer (20) and inner (21) surfaces of the door 2 are aligned in the combined image 22 of the outer and inner surfaces of the door 2. These target areas 1 are used as reference points to align the scanned images.

FIG. 6 is a graphical illustration of how the data of the combined image of the edge of the door and the scanned image of the body side of the door opening surface(s) are aligned into a position in which the door is fully closed and latched. FIG. 6 includes the combined image 22 of the outer and inner surfaces of the door 2 discussed above in reference to FIG. 5. In FIG. 6 the cloud point data obtained by image scanning the body side door opening surface 23 and the combined image 22 of the outer and inner surfaces of the door 2 is manipulated using a conventional software program such as Polyworks® to position the combined image 22 of the outer and inner surfaces of the door 2 against the image 23 of the body side door opening surface so that the combined door image 23 is in the closed and latched position. In order to position the combined image 22 of the outer and inner surfaces of the door 2 against the image 23 of the body side door opening surface so that the combined door image 22 it in the closed and latched position, the target areas 1 are aligned in the positions depicted in FIG. 2 from when the gap and flush image of the door was scanned.

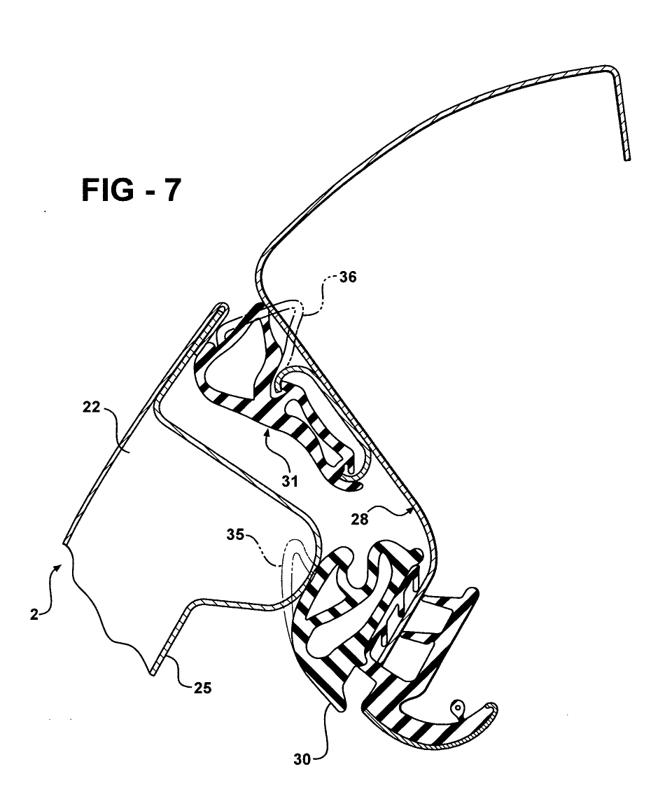

The space 24 between the inner surface 25 of the door 2 and the body side surface 28 of the door opening is where the sealing element analysis is performed as discussed in more detail below in reference to FIG. 7. In FIG. 6 the roof of the automobile is identified by reference numeral 4

FIG. 7 is depicts a cross-section analysis of the image data as combined in FIG. 6 and taken along section lines 7-7 in FIG. 2. Since the inner surface 25 of the door 2 and the body side door opening surface 28 are image scanned when the door 2 is opened, the sealing elements 30 and 31 on these surfaces are not compressed during the image scanning. However, when the door 2 is in its fully closed and latched positioned, the sealing elements 30 and 31 located between the inner surface 25 of the door 2 and the body side door opening surface 28 are compressed at contacts points as illustrated. FIG. 7 illustrates how the performance of the sealing elements can be evaluated. As discussed herein, the “performance” of the sealing elements includes, but is not limited to, the manner in which the sealing elements are compressed, deflected, distorted, etc. to prevent wind noise, water leakage, excessive door closing force, and proper alignment of the door upon closing.

As shown in FIG. 7, when the combined image 22 of the outer and inner surfaces of the door 2 and the image of the body side door opening surface 28 are positioned so that the door 2 is in its fully closed and latched position, areas where the opposed images overlap can be used to identify seal interference areas 35 and 36. In these seal interference areas 35 and 36 the leading edge of the seal will have to deflect, deform, compress, etc. as the seals are pressed against the opposing surface. In FIG. 7 the geometry or cross-sectional configuration of the sealing elements 30 and 31, which is known at the time a particular sealing element is chosen for a door assembly, is combined with the image of the inner surface 25 of the door and the image of the body side door opening. From the geometry or configuration of the sealing elements 30 and 31 and the properties of the material from which the sealing elements 30 and 31 are made, it can be determined how the sealing elements 30 and 31 will deflect, distort, etc. at the seal interference areas 35 and 36 that can be identified in FIG. 7. Moreover, from the geometry or configuration of the sealing elements 30 and 31 and the properties of the material from which the sealing elements 30 and 31 are made, the amount of compression or pressure at the seal interference. In addition to identifying and evaluating sealing element interference, areas where sealing element contact is intended but lacking can also be evaluated.

Thus, it can be understood how the method of the present invention allows for evaluating how sealing elements will perform under compression between two adjacent structures in a noninvasive manner using non-contact imaging and manipulation and analysis of image data sets.

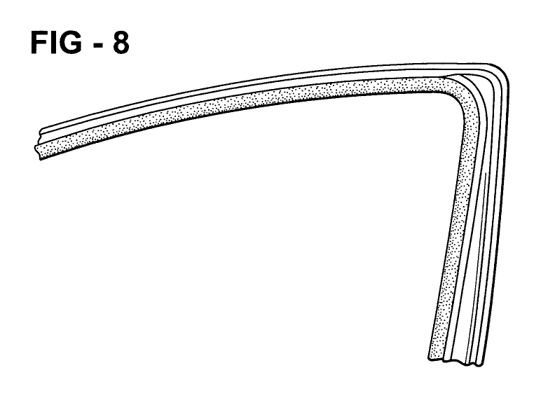

FIG. 8 is a scanned image of the body side of a door. In general, FIG. 8 depicts how accurate the contour of the body side door can be imaged.

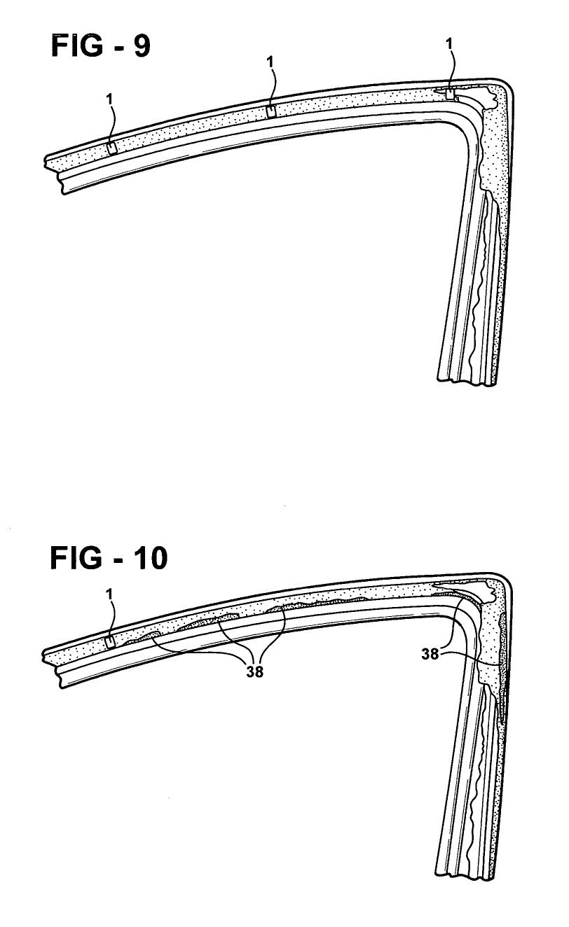

FIG. 9 is a combined image of the complete edge of the door formed by merging separate scanned images of the outer and inner door surfaces. In FIG. 9 the target areas 1 which are used to combine the separate scanned images of the inner and outer surfaces of the door can be seen.

FIG. 10 is a combined image of the door (merged the outer and inner surfaces of the door) and the body side door opening surface. FIG. 10 depicts target areas 1 and seal interference areas 38. In order to more easily observe the seal interference areas 38, the combined image of the door and the image of the body side door opening surface can be displayed and combined as different colored images which is indicated in FIG. 10.

The analysis of sealing element performance according to the present invention allows for the identification of seal interference areas (or non-contacting areas) and the accurate prediction of how sealing elements will perform, i.e. compress, deflect, distort, etc., between the surfaces of adjacent structures. This information can be used to determine areas where sealing problems, e.g. wind noise, fluid leakage, excessive closing force, etc. can be expected to occur so that remedial actions can be taken or the sealing elements can be replaced, redesigned, reconfigured or aligned.

The manner in which scanned images are used to determine actual seal element performance according to the present invention enables the method to be used to design sealing elements. For example, in the case of an automobile door seal, a sealing element configuration could be initially designed (actually or virtually) and added to the scanned images of the inner door surface and/or body side door opening surface as exemplified in FIG. 7. When the inner door surface and body side door opening surface are positioned in the door's fully closed and latched position, interference areas (or non-contacting areas) of the sealing element configuration could be used to evaluate sealing element performance as discussed above. Redesigning the sealing element would only require adding a redesigned or modified sealing element configuration to the scanned images of the inner door surface and/or body side door opening surface. Such a process amounts to the virtual testing and designing or sealing elements.

Although the present invention has been described with reference to particular means, materials and embodiments, from the foregoing description, one skilled in the art can easily ascertain the essential characteristics of the present invention and various changes and modifications can be made to adapt the various uses and characteristics without departing from the spirit and scope of the present invention as described above.

What is claimed is:

1. A method of evaluating the performance of sealing elements that are confined between adjacent surfaces which method comprises the steps of:
a) providing a first surface structure and a second surface structure which can be moved with respect to one another between a first close proximity position and a second spaced apart position;
b) providing at least one sealing element on one of the first surface structure and the second surface structure;
c) obtaining a three dimensional image of each of the first and second surface structures with the at least one sealing element thereon;
d) arranging the three dimensional images of the first and second surface structures in the first close proximity position and identifying areas where the three dimensional image of the at least one sealing element will intersect the image of the opposed surface structure when the first and second surface structures are arranged in the first close proximity position; and
e) evaluating from the three dimensional images how the at least one sealing element will interact with and between the first and second surface structures in the first close proximity position.

2. A method of evaluating the performance of sealing elements that are confined between adjacent surfaces according to claim 1, wherein the first and second surface structures comprise an exterior compartment closure of a vehicle and a corresponding compartment opening of the vehicle.

3. A method of evaluating the performance of sealing elements that are confined between adjacent surfaces according to claim 2, wherein the exterior compartment closure comprises a door.

4. A method of evaluating the performance of sealing elements that are confined between adjacent surfaces according to claim 1, wherein step c) comprises optically scanning the first and second surface structures.

5. A method of evaluating the performance of sealing elements that are confined between adjacent surfaces according to claim 1, wherein step e) of evaluating comprises evaluating at least one of the compression, distortion and deflection of the at least one sealing element.

6. A method of evaluating the performance of sealing elements that are confined between adjacent surfaces according to claim 1, wherein the performance evaluated comprises at least one of wind noise reduction, fluid leakage prevention and required closing force.

7. A method of evaluating the performance of sealing elements that are confined between compartment openings and closures configured to seal at least a portion of a compartment opening, the method comprising the steps of:
a) providing a compartment having an opening therein, the opening including a peripheral opening surface area;
b) providing a closure configured to seal at least a portion of the compartment opening, said closure having both inner and outer surfaces;
c) providing a three dimensional reference image of the closure positioned so as to seal the opening;
d) providing and combining three dimensional images of the inner and outer surfaces of the closure to produce a combined three dimensional closure image;
e) providing a three dimensional image of the peripheral opening surface area;
f) aligning the combined three dimensional closure image with the three dimensional image of the peripheral opening surface area so as to confirm to the three dimensional reference image;
g) incorporating the configuration of at least one sealing element between the three dimensional image of the inner surface of the door and the three dimensional image of the peripheral opening surface area in step f); and
h) evaluating how the at least one sealing element interacts with and between the three dimensional image of the inner surface of the door and the three dimensional image of the peripheral opening surface area in step g).

8. A method of evaluating the performance of sealing elements that are confined between compartment openings and closures configured to seal at least a portion of a compartment opening according to claim 7, wherein the compartment comprises a motor vehicle body.

9. A method of evaluating the performance of sealing elements that are confined between compartment openings and closures configured to seal at least a portion of a compartment opening according to claim 8, wherein the closure comprises a door.

10. A method of evaluating the performance of sealing elements that are confined between compartment openings and closures configured to seal at least a portion of a compartment opening according to claim 7, wherein between steps b) and c) an additional step i) of establishing reference target areas around the closure and adjacent portions of the compartment is provided.

11. A method of evaluating the performance of sealing elements that are confined between compartment openings and closures configured to seal at least a portion of a compartment opening according to claim 10, wherein the reference target areas are recognizable by optical scanners.

12. A method of evaluating the performance of sealing elements that are confined between compartment openings and closures configured to seal at least a portion of a compartment opening according to claim 11, wherein in steps d) and f) the images are combined by aligning the reference target areas.

13. A method of evaluating the performance of sealing elements that are confined between compartment openings and closures configured to seal at least a portion of a compartment opening according to claim 7, wherein steps c), d) and e) comprise using an optical scanner to produce each of the three dimensional images.

14. A method of evaluating the performance of sealing elements that are confined between compartment openings and closures configured to seal at least a portion of a compartment opening according to claim 7, wherein step h) comprises evaluating areas where the at least one sealing element will intersect or fail to contact an opposed image surface.

15. A method of evaluating the performance of sealing elements that are confined between compartment openings and closures configured to seal at least a portion of a compartment opening according to claim 7, wherein step h) of evaluating comprises evaluating at least one of the compression, distortion and deflection of the at least one sealing element.

16. A method of evaluating the performance of sealing elements that are confined between compartment openings and closures configured to seal at least a portion of a compartment opening according to claim 7, wherein the performance evaluated comprises at least one of wind noise reduction, fluid leakage prevention and required closing force.

17. A method of designing sealing elements which comprises the method steps of claim 1 and the additional step f) of using the evaluation from step e) to redesign a configuration of the at least one sealing element to improve the performance thereof.

18. A method of designing sealing elements which comprises the method steps of claim 3 and the additional step f) of using the evaluation from step e) to redesign a configuration of the at least one sealing element to improve the performance thereof.

19. A method of designing sealing elements which comprises the method steps of claim 7 and the additional step i) of using the evaluation from step h) to redesign a configuration of the at least one sealing element to improve the performance thereof.

20. A method of designing sealing elements which comprises the method steps of claim 9 and the additional step i) of using the evaluation from step h) to redesign a configuration of the at least one sealing element to improve the performance thereof.
